(19) United States
(12) Patent Application Publication
(10) Pub. No.: US 2007/0225476 A1
(43) Pub. Date: Sep. 27, 2007

(54) Method for producing fibrilliform crystal of aromatic polyester

(75) Inventor: Satoshi Okamoto, Tsukuba-shi (JP)

Correspondence Address: FOLEY AND LARDNER LLP;SUITE 500, 3000 K STREET NW, WASHINGTON, DC, 20007, US

(73) Assignee: Sumitomo Chemical Company, Limited

(21) Appl. No.: 11/715,355

(22) Filed: Mar. 8, 2007

(30) Foreign Application Priority Data
Mar. 24, 2006 (JP) 2006-682757

(51) Int. Cl. C08G 63/02; C08L 67/04

(52) U.S. Cl. 528/361

(57) ABSTRACT

Fibrilliform crystal of an aromatic polyester can be obtained easily by the method comprising a step of polymerizing an aromatic hydroxycarboxylic acid in a solvent at a temperature in the range of from 200° C. to 400° C. under presence of an acid anhydride.

### BACKGROUND OF THE INVENTION

1. Field of the Invention

The present invention relates to a method for producing fibrilliform crystal of aromatic polyester of which repeating unit is derived from an aromatic hydroxycarboxylic acid.

2. Description of the Related Art

Recently, composite materials are noted from the demand of highly efficient materials, and some materials to which some functions are given by adding various fillers to thermoplastic resins and thermosetting resins have been proposed. As for these fillers, especially for fibrous (or fibrilliform) fillers and whiskers, inorganic fillers are usually used. Organic fillers consisting of organic polymers are seldom used since the fibrilliform crystal of the polymers is difficult to be produced, while aromatic polyester in the form of fibrillate crystal is known to be very useful as organic fillers for composite materials due to its excellent heat resistance, low water absorbing property, electrical property, stiffening effect and the like. Therefore, various methods for producing the aromatic polyester in the form of fibrilliform crystal have been researched so far. For example, Japanese Patent Application Laid-Open (JP-A) No. 61-136516 (corresponding to U.S. Pat. No. 4,673,724) discloses a method for producing a polymer whisker in which a hydroxyl group of an aromatic hydroxycarboxylic acid as a starting raw material is converted into a highly reactive group to obtain a corresponding acid ester and then the ester is polymerized. Moreover, JP-A No. 6-136102 discloses a method for producing a polyester fibrilliform crystal in which a hydroxyl group or a carboxylic acid group of 4′-hydroxybiphenyl-4-carboxylic acid as a starting raw material is converted into a highly reactive group and then the resulting material is polymerized.

Since in both of the production methods described above, the hydroxyl group and/or the carboxylic acid group of the aromatic hydroxycarboxylic acid as a starting raw material is converted into a high reactive group and then polymerized, it is necessary to prepare the material having such a high reactive group in high purity prior to the polymerization step. Therefore, complex steps of processes are needed to execute these production methods industrially.

### SUMMARY OF THE INVENTION

Considering the above-mentioned circumstances, the present inventors zealously studied to find a method for producing an aromatic polyester in the form of fibrillate crystal. As a result, the present inventors have found a method for producing an aromatic polyester in the form of fibrillate crystal, which can be obtained by directly polymerizing an aromatic hydroxycarboxylic acid.

The present invention provides a method for producing an aromatic polyester, the method comprising a step of polymerizing an aromatic hydroxycarboxylic acid in a solvent at a temperature in the range of from 200° C. to 400° C. under presence of an acid anhydride.

The method in the present invention is industrially advantageous, since an aromatic polyester in the crystal form, especially an aromatic polyester in the form of fibrilliform crystal, can be obtained simply in high productivity. Such an aromatic polyester may be utilized as an organic filler excellent in heat resistance, low water absorbing property, electrical property and the like.

### BRIEF DESCRIPTION OF THE DRAWING

FIG. 1 shows electron micrograph (magnification is 3000 times) of the aromatic liquid crystal polyester obtained by Example 1.

### DETAILED DESCRIPTION OF THE PREFERRED EMBODIMENTS

The present invention provides a method for producing an aromatic polyester, the method comprising a step of polymerizing an aromatic hydroxycarboxylic acid in a solvent at a temperature in the range of from 200° C. to 400° C. under presence of an acid anhydride. The aromatic polyester can be obtained in the fibrilliform (fibrillate) crystal.

The “fibrilliform crystal” in the present invention is a fiber-like crystal, which may comprise a single crystal. The crystal may have a length (L) of from 1 to 200 μm, a diameter (D) of from 0.1 to 5 μm and the ratio L/D of from 10 or more.

Each of the fibrilliform crystals may exist independently, or may form the state of the fiber assembly.

An aromatic hydroxycarboxylic acid utilized in the present invention may have an aromatic ring together with a (phenolic) hydroxy group and a carboxylic acid group, both of which bind directly to the aromatic ring. Examples of the aromatic hydroxycarboxylic acid include 4-hydroxybenzoic acid, 3-hydroxybenzoic acid, 2-hydroxybenzoic acid, 6-hydroxy-2-naphthoic acid, 3-hydroxy-2-naphthoic acid, 2-hydroxy-1-naphthoic acid, 1-hydroxy-2-naphthoic acid and 4-hydroxy-4′-biphenylcarboxylic acid.

Among these, it is preferred to use 4-hydroxycarboxylic acid, 6-hydroxy-2-naphthoic acid, 4-hydroxy-4′-biphenylcarboxylic acid and the like, since they are easily available and excellent in polymerization.

A solvent used in the polymerization in the present invention is not especially limited as long as it is a liquid and has fluidity in the reaction temperature described later. The solvent may be a solvent having a boiling point lower than the reaction temperature at normal pressure (about 1013 hPa) as long as the solvent is able to maintain its liquidity under pressure in the polymerization reaction. The solvent used in the polymerization preferably has a boiling point of from 200° C. or higher. In using such a solvent, the polymerization can be carried out under normal pressure.

In the present invention, the aromatic polyester obtained in the polymerization is preferably insoluble or hardly soluble in the solvent. The solubility of the aromatic polyester is preferably in the range of from 0 to 0.1% by weight. The aromatic polyester with more excellent crystallinity can be obtained by using such a solvent.

Examples of the solvent include substituted naphthalenes substituted biphenyls, substituted triphenyls, benzophenone and paraffin hydrocarbons. Specifically, examples of the solvent include aromatic compounds such as diisopropylnaphthalene, diethylnaphthalene, ethyl-isopropylnaphthalene, cyclohexylbiphenyl, diethylbiphenyl, triethylbiphenyl, triphenyl hydride, diphenyl sulfone, benzophenone, and diphenyl ether, and aliphatic compounds such as paraffin hydrocarbons having a boiling point of 200° C. or more at normal pressure. Among these, those having fluidity at temperatures of 190° C. or more are preferable, and particularly paraffin hydrocarbons, triethylbiphenyl, triphenyl hydride and the like are more preferable. Especially, paraffin hydrocarbons are suitable from the viewpoints of availability and handling character.

Among those paraffin hydrocarbons, a paraffin hydrocarbon having a melting point of 40° C. or higher is preferred, the melting point of which may be measured in paraffin wax melting point test provided in JIS K2235 (in 1980, “petroleum wax”). Such a solvent tends to have a boiling point of 200° C. or higher, desirably.

In the above-mentioned JIS K2235, paraffin hydrocarbons are classified depending on their melting points. For example, a solvent having a melting point of 48.9° C. or higher and of lower than 51.7° C. is classified in the group of “120P”. In the present invention, all of the paraffin hydrocarbons classified into the groups of from 120P to 155P in JIS K2235 can be used. It is preferred in the present invention to use a solvent with a melting point of 65° C. or lower. That is, it is preferred in the present invention to use a paraffin hydrocarbon classified in 120P (of which melting point is 48.9° C. or higher and lower than 51.7° C.), 125P (of which melting point is 51.7° C. or higher and lower than 54.4° C.), 130P (of which melting point is 54.4° C. or higher and lower than 57.2° C.), 135P (of which melting point is 57.2° C. or higher and lower than 60.0° C.), or 140P (of which melting point is 60.0° C. or higher and lower than 62.7° C.).

The above-described paraffin hydrocarbons may be straight chain hydrocarbons, branched hydrocarbons or mixtures of them, and may contain an alicyclic hydrocarbon such as naphthene. Paraffin hydrocarbons commercially available, which may consist mainly of straight chain hydrocarbons and have a carbon number of 20 to 48, can also be used. Among those, a paraffin hydrocarbon having a melting point of 40° C. or higher can be easily selected and utilized.

In the present invention, the polymerization of the aromatic hydroxycarboxylic acid is conducted in an acid anhydride. The acid anhydride is not especially limited. Examples of the acid anhydride include aliphatic acid anhydrides such as acetic anhydride, propionic anhydride, butyric anhydride, isobutyric anhydride, and hexanoic anhydride, and aromatic acid anhydrides such as benzoic anhydride and phthalic anhydride. Acetic anhydride is particularly preferred in terms of availability and the easiness of handling.

The acid anhydride may be used in the amount of from 1 to 1.5 molar equivalent weight, is preferably used in the amount of from 1.02 to 1.15 molar equivalent weight, and is more preferably used in the amount of from 1.05 to 1.1 molar equivalent weight, on the basis of 1 mole of the aromatic hydroxycarboxylic acid.

The production method of the present invention may be conducted using a mixture of an aromatic hydroxycarboxylic acid, an acid anhydride and a solvent, to polymerize the aromatic hydroxycarboxylic acid at a temperature of from 200° C. to 400° C. In such a mixture, it is suitable that the concentration of the aromatic hydroxycarboxylic acid is in the range of from 0.1 to 5% by weight based on 100% by weight of the total amount of the aromatic hydroxycarboxylic acid and the solvent. When the concentration of the aromatic hydroxycarboxylic acid is 0.1% by weight or more, the resulting aromatic polyester can be easily purified, desirably. Also, when the concentration of the aromatic hydroxycarboxylic acid is 5% by weight or less, the crystallinity of the fibrilliform aromatic polyester is more improved, desirably. The concentration of the aromatic hydroxycarboxylic acid is more preferably in the range of from 0.5 to 4.5% by weight, and further preferably 1 to 3% by weight.

A polymerization temperature can be arbitrarily set in the range of from 200° C. to 400° C. When the temperature is lower than 200° C., it may be difficult to obtain a fibrilliform aromatic polyester crystal, and at the same time, the degree of polymerization of the aromatic polyester tends to be insufficient. When the polymerization temperature is higher than 400° C., problems such as damaging the reactor due to corrosion and the like may be caused. The temperature is preferably in the range of from 250° C. to 350° C., and is more preferably in the range of from 280° C. to 320° C.

The reaction time for producing the aromatic polyester in the present invention can be arbitrarily set as long as the degree of polymerization of the aromatic polyester becomes enough. The reaction time may be in the range of from 0.5 to 50 hours. When the reaction time is 0.5 hours or longer, the yield of fibrilliform crystals may highly improved. When the reaction time is 50 hours or shorter, the productivity of the aromatic polyester per unit time becomes excellent, which is advantageous for industrial production. The reaction time is preferably 1 to 20 hours, and more preferably 2 to 10 hours.

In the method for producing the aromatic polyester of the present invention, a polymerization catalyst is preferably used to more improve the productivity of the polymer. As such a polymerization catalyst, a basic catalyst is preferred. Examples of the catalyst include organic base compounds, and basic inorganic salts such as potassium acetate and sodium acetate.

Among the basic catalysts for the porimerization, heterocyclic organic base compounds containing a nitrogen atom are suitable. Specific examples of the heterocyclic organic base compounds include pyridine derivatives, imidazole derivatives, pyrazole derivatives, pyridazine derivatives, pyrimidine derivatives, indole derivatives, quinoline derivatives, purine derivatives, phthalazine derivatives, and carbazole derivatives. Among these, imidazole derivatives that the present inventors described in JP-A No. 2002-146003 are particularly suitable.

The above-mentioned imidazole derivatives include, for example, those indicated by formula (1) below:

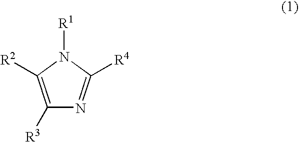

### [In the formula, R¹ to R⁴ each independently indicate hydrogen atom or an alkyl group having 1 to 4 carbon atoms.]

Imidazole derivatives indicated by formula (1) include imidazole, 1-methylimidazole, 2-methylimidazole, 4-methylimidazole, 1-ethylimidazole, 2-ethylimidazole, 4-ethylimidazole, 1,2-dimethylimidazole, 1,4-dimethylimidazole, 2,4-dimethylimidazole, 1-methyl-2-ethylimidazole, 1-methyl-4-ethylimidazole, 1-ethyl-2-methylimidazole, and 1-ethyl-2-ethylimidazole. Among them, 1-methylimidazole and 1-ethylimidazole are preferable because of easily available industrially.

The polymerization catalyst may be used in the range of from 0.001 to 1% by weight, is preferably in the range of from 0.01 to 0.5% by weight, and is more preferably in the range of from 0.05 to 0.3% by weight, on the basis of the aromatic hydroxycarboxylic acid.

As mentioned above, the method for producing the aromatic polyester of the present invention can be conducted by polymerizing an aromatic hydroxycarboxylic acid, while the aromatic hydroxycarboxylic acid is mixed with an acid anhydride, solvent and the optional polymerization catalyst. Here, the order of feeding (mixing) of the components for preparing the mixture is not especially limited. For example, all the components may be added and mixed together at once, or one or two component(s) may be added later than the others at the above-mentioned reaction temperature or at the temperature lower than the reaction temperature.

The stirring speed is not especially limited as long as the reaction temperature can be maintained uniformly in a reaction vessel. It is preferred to decrease the stirring speed while raising the temperature, since under such a condition, the crystallinity of the aromatic polyester tends to be more excellent and the fibrilliform crystals are obtained in high yield.

In the more preferred method, the steps of the following step (A), (B) and (C) are contained in this order.

Step (A): a step of raising the temperature of the mixture including an acid anhydride, an aromatic hydroxycarboxylic acid and a solvent up to a temperature of from 100 to 130° C., while stirring the mixture.

Step (B): a step of stirring the mixture at a stirring speed lower than that in step (A).

Step (C): a step of polymerizing the aromatic hydroxycarboxylic acid by raising the temperature up to a temperature of from 200° C. to 400° C.

The above-mentioned step (A) is a step for obtaining the mixture before the polymerization, and the optional polymerization catalyst can be mixed therein. In step (A), the mixture may be obtained at a temperature in the range of from 10 to 50° C. (and is preferably a room temperature (about 20° C.)), and then the temperature of the resulting mixture may be raised while stirring the mixture. Step (B) is a step in which the temperature rise is stopped once at the stage where the internal temperature arrives at temperatures of from 100 to 130° C., and the stirring speed is lowered than that in step (A). The stirring speed is preferable to be lowered since the crystallinity of the aromatic liquid crystal polyester tends to finally become excellent as the stirring speed is lowered. The stirring may be stopped if the temperature can be maintained uniformly in the reaction vessel.

In step (C), the temperature of the mixture is raised up to a temperature of from 200° C. to 400° C. or less, which is a polymerization reaction temperature in the present invention. as shown in (C), and the polymerization is conducted. It is suitable to pass steps of (A), (B) and (C) to make both of the crystallinity and the degree of polymerization of the resulting aromatic liquid crystal polyester become high.

In the present invention, the fibrilliform crystals of aromatic polyester can be obtained in the above-described method. The aromatic polyester is excellent in heat resistance, low water absorbing property, electrical property and/or reinforcing effect. Such an aromatic polyester is preferably used as a organic filler for thermoplastic resins and thermosetting resins, and can be used suitably in the fields including automobile industry, aviation industry and electronic and electric industry.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2006-082757 filed on Mar. 24, 2006, including specification, claims, drawings and summary, are incorporated herein by reference in their entirety.

### EXAMPLES

The present invention is described in more detail by following Examples, which should not be construed as a limitation upon the scope of the present invention.

### Example 1

In a 500 ml separable flask equipped with a nitrogen gas introduction pipe, a thermometer, a stirrer, and a distilling pipe, 300 g of paraffin (the melting point is 48 to 50° C., a purchased item from Wako Pure Chemical Industries, Ltd.), 4.5 g or 4-hydroxybenzoic acid, 3.7 g of acetic anhydride, and 4.3 mg of N-methylimidazole were added, and the mixture was stirred at the stirring speed of 200 rpm under the nitrogen atmosphere and the internal temperature was raised from room temperature to 110° C. at the temperature rise speed of 10° C./minute and then the stirring was stopped after the contents had been confirmed to have been completely dissolved. After that, the internal temperature was raised again to 305° C.

The internal temperature was decreased to 280° C. from 305° C. over 30 minutes, and was kept at the temperature for six hours. Then, the contents were cooled to 150° C., and the obtained precipitate was separated by filtration. The filtered solid was washed with 500 ml of hexane, 500 ml of toluene, and 500 ml of acetone sequentially, and was dried at 120° C. under reduced pressure for 10 hours to obtain aromatic liquid crystal polyester.

As to the aromatic liquid crystal polyester, 5%-weight-loss beginning temperature, at which the weight of polyester obtained after heating was decreased by 5% compared to the weight of the polyester obtained before heating, was 505° C. in analysis with the heat balance (the temperature rise speed of 5° C./minute, under airflow), and an endothermic peak was observed at 330° C. as a result of the scanning calorimetric analysis (the temperature rise speed of 5° C./minute, under airflow). However, the polymer did not melt though being kept at the temperature or higher.

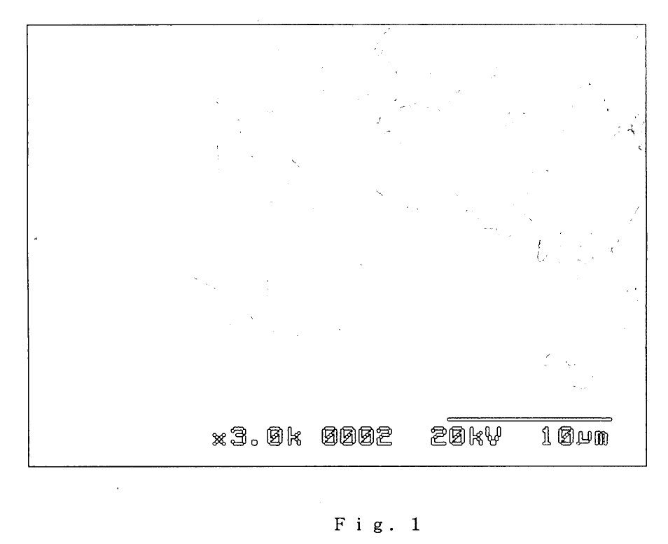

Moreover, the electron micrograph (expansion magnification: 3000 times) of the crystal condition of the obtained aromatic liquid crystal polyester is shown in FIG. 1. It was confirmed that the aromatic liquid crystal polyester was the desired fibrilliform crystal.

1. A method for producing an aromatic polyester, the method comprising a step of polymerizing an aromatic hydroxycarboxylic acid in a solvent at a temperature in the range of from 200° C. to 400° C. under presence of an acid anhydride.

2. The method for producing an aromatic polyester according to claim 1, wherein the solvent comprises a solvent selected from the group consisting of substituted naphthalenes substituted biphenyls, substituted triphenyls, benzophenone and paraffin hydrocarbons.

3. The method for producing an aromatic polyester according to claim 2, wherein the solvent comprises a solvent selected from the group consisting of diisopropylnaphthalene, diethylnaphthalene, ethyl-isopropylnaphthalene, cyclohexylbiphenyl, diethylbiphenyl, triethylbiphenyl, triphenyl hydride, diphenyl sulfone, benzophenone and diphenyl ether.

4. The method for producing an aromatic polyester according to claim 2, wherein the solvent comprises a paraffin hydrocarbon.

5. The method for producing an aromatic polyester according to claim 1, wherein the solvent has a solvent in which the aromatic polyester has a solubility of 0.1% by weight or smaller.

6. The method for producing an aromatic polyester according to claim 4, wherein the paraffin hydrocarbon is a paraffin hydrocarbon having a melting point of 40° C. or higher.

7. The method for producing an aromatic polyester according to claim 1, wherein the aromatic hydroxycarboxylic acid is used in the range of from 0.1 to 5% by weight based on 100% by weight of the total of the aromatic hydroxycarboxylic acid and the solvent.

8. The method for producing an aromatic polyester according to claim 1, wherein the polymerization is conducted in the presence of a heterocyclic organic base compound containing a nitrogen atom.

9. The method for producing an aromatic polyester according to claim 8, wherein the base compound comprises an imidazole derivative.

10. The method for producing an aromatic polyester according to claim 1, wherein the acid anhydride is acetic anhydride.

11. The method for producing an aromatic polyester according to claim 1, wherein the method comprising, in the following order, the steps of:
(A) raising a temperature of a mixture including an acid anhydride, an aromatic hydroxycarboxylic acid and a solvent up to the range of from 100° C. to 130° C., while stirring the mixture;
(B) stirring the mixture at a stirring speed lower than that in step (A); and
(C) raising the temperature of the mixture up to the range of from 200° C. to 400° C. to polymerize the aromatic hydroxycarboxylic acid.
